(19) United States
(12) Patent Application Publication
(10) Pub. No.: US 2012/0280607 A1
(43) Pub. Date: Nov. 8, 2012

(54) Appliance With Frontal Installation Adjustment

(76) Inventors: Andrew J. Doberstein, Hartford, WI (US); Joseph H. Zyduck, Mukwonago, WI (US)

(21) Appl. No.: 13/100,727

(22) Filed: May 4, 2011

(51) Int. Cl. F25D 23/00; B23P 11/00; A47B 91/02

(52) U.S. Cl. 312/401; 312/351.1; 29/428

(57) ABSTRACT

An appliance, such as a cooling unit, has its installation adjustment provided at a front side of its cabinet. The adjustment features can include a mechanism for adjusting the height of the back side of the cabinet from the front as well as a toe kick grille that provides front-to-back and height adjustment from the front. Specifically, a flexible connector transfers rotational input applied to an adjuster interface located at a front side of the cabinet to one or more rear legs to raise or lower the back side of the cabinet. And a front-to-back slidable kick panel mounts a floor gate, which itself can slide up and down. A method of installing an appliance provides leveling the cabinet, including adjusting the rear legs, and positioning a toe kick, all from the front side of the cabinet.

### CROSS-REFERENCE TO RELATED APPLICATIONS

Not applicable.

### STATEMENT OF FEDERALLY SPONSORED RESEARCH OR DEVELOPMENT

Not applicable.

### BACKGROUND

1. Technical Field

The present disclosure relates to adjustable installation components for appliances such as refrigerated food and drink cold storage units and the like.

2. Description of the Related Art

Appliances of various types, such as refrigerators, dish washers, ice makers, trash compactors, washers and dryers, are well known. Particularly it is known that some appliances, such as coolers for the cool storage of food and beverages, can come in full-size standup units or compact, under-counter units. And it is also common for such appliances to be installed in a kitchen next to other appliances or cabinets.

When installing cooling units, for example, care must be taken to level the units to ensure proper operation as well as to facilitate proper door movement and closure. To allow leveling, legs at the bottom of the cabinet are made adjustable so that the front, rear and/or sides of the cabinet can be raised or lowered as needed. Typically, this is done by simply threading the individual legs more or less into the bottom of the cabinet. Backing a leg out of the cabinet raises the associated side and threading it in lowers it. An example of this can be found in published US patent application 2006/0042306.

Various refinements to the conventional threaded legs have been devised. For example, U.S. Pat. No. 6,871,826 discloses a thumb-actuated and spring-biased adjustable leg assembly with a stem having ACME-type threads. The assembly provides quick adjustability without sacrificing the integrity of the connection to the cabinet.

However, in both cases in order to level the cooling unit, each leg must be manually manipulated. Moreover, weight must be taken off of the leg to facilitate adjustment. This results in two problems. First, the installer must lift the side or corner of the cabinet that is being adjusted, while at the same time making the adjustment. Second, to adjust the rear legs, either the installer must reach his or her hand beneath or to the side of the cabinet, or the entire cooling unit must be pulled out from its installation position so that the leg can be adjusted, and then the unit must be repositioned. The cooling unit could need to be pulled out and repositioned repeatedly until proper leveling is achieved.

To address these problems, “automatic” and electronic leveling systems have been devised. For example, U.S. Pat. No. 7,744,049 discloses an “automatic” leveling leg for an appliance which is designed to accommodate vibrations encountered during use. The leg has a cylinder which houses a movable piston that is biased by a coil spring. The rather complex assembly provides level adjustment by interaction of the spring and piston, which causes the leg to reset at a new position corresponding to the equilibrium point of the spring force and the weight on the leg. This provides only a partial solution to the aforementioned problems in that it is leg-site specific and still requires the weight on the leg to be altered for manual adjustment.

U.S. Pat. No. 5,732,914 discloses an electronic system that detects an unlevel condition and then levels the refrigerator. The disclosed system includes multiple motor and gear assemblies for driving the legs at the four corners of the cabinet in response to a level determining mechanism mounted to the bottom of the cabinet. The level determining mechanism includes upper and lower plates on each side of a switching device which electrically connects the motor to power. The switching devices includes four upper terminals mounted to the upper plate and four lower terminals mounted to the lower plate in registration with the upper terminals. A connecting member selectively connects the upper and lower terminals together according to the levelness of the cabinet, in which case one or more of the motors are energized and the appropriate leg(s) are raised or lowered. Thus, this system uses a significantly more complex and costly powered system to level the refrigerator.

Apart from the issue of leveling, another problem that arises when installing a cooling unit is alignment of the recessed grille area at the lower front of the unit, sometimes referred to as the “toe kick,” with the adjacent cabinetry to achieve a more seamless and aesthetically appealing integration of the appliance and cabinetry. Conventionally, alignment with the toe kick is achieved by repositioning the entire cooling unit forward or backward until it is aligned. However, depending on the depth of the cabinets and/or the cooling unit, flush alignment may not possible with the conventional technique.

Accordingly, further refinements are needed to address the noted problems of the existing art.

### BRIEF SUMMARY

The disclosure relates to overcoming the aforementioned problems and provides improved mechanisms for making adjustments from the front side of an appliance, such as a cool storage unit or the like.

Specifically, in one aspect the appliance has a cabinet with a front side and a back side. At least one leg is adjustably mounted to the cabinet to support the cabinet and adjust the height of the back side of the cabinet. An adjuster interface located at a front side of the cabinet is coupled by a flexible connector to the leg. The flexible connector transfers rotational force applied at the adjuster interface to the leg to raise or lower the back side of the cabinet.

The adjuster interface can have a tool receptor coupled to a proximal end of the flexible connector. The tool receptor can have a recess with at least one flat interior surface. The cabinet can also have a leg interface coupled to a distal end of the flexible connector. The leg can have a threaded stem threadedly engaging the cabinet and a portion for engaging the leg interface. The leg interface can have a leg receptor with a recess having at least one flat interior surface and the leg has a flat surface engaging the at least one flat interior surface of the leg receptor. The recesses of the tool receptor and the leg receptor can open in different planes that are at an angle to one another.

In another aspect the front side of the cabinet has a lower recess, such as a recessed grille area, adjacent to the bottom of the cabinet. A toe kick panel is mounted to the cabinet at the lower recess which can be adjusted in the direction between the front and back sides of the cabinet. A floor gate is mounted to the toe kick panel and can be adjusted in the direction between the top and bottom sides of the cabinet.

The toe kick panel can be slidably mounted to the cabinet and the floor gate can be slidably mounted to the toe kick panel. The toe kick panel can have a side wall at an angle to a front wall, and the side wall can have a slot extending in a direction between the front and back sides of the cabinet in which a fastener mounted to the cabinet is disposed. Either the toe kick panel or the floor gate can have a bent over end that forms a channel which receives an associated end of the other of the toe kick panel and the floor gate.

In yet another aspect the disclosure provides a method of installing an appliance. The method includes leveling the cabinet and/or positioning a toe kick at a lower recess at the front side of the cabinet. Leveling the cabinet can include: applying a rotational force to an adjuster interface located at the front side of the cabinet and transferring the rotational force applied at the adjuster interface along a flexible connector to at least one leg adjustably mounted to the cabinet, with the flexible connector rotating the leg to adjust the height of the back side of the cabinet. Positioning the toe kick can include: adjusting a kick panel of the toe kick mounted to the cabinet in the direction between the front and back sides of the cabinet, and adjusting a floor gate mounted to the kick panel in the direction between the top and bottom sides of the cabinet.

These and still other advantages will be apparent from the following detailed description of the drawings. To assess the full scope of the invention the claims should be looked to as the construction(s) shown in the drawings and described below are not limiting.

### BRIEF DESCRIPTION OF THE DRAWINGS

FIG. 1 is a perspective view of an exemplary appliance in the form of a cooling unit having the features of the present invention;

FIG. 2 is an enlarged partial perspective view thereof showing one rear leg adjustment mechanism;

FIG. 3 is a partial exploded assembly view thereof;

FIG. 4 is a partial exploded assembly view of the cooling unit of FIG. 1 showing an exemplary toe kick adjustment mechanism;

FIG. 5 is a partial side sectional view taken along line 5-5 of FIG. 1 showing the exemplary toe kick adjustment mechanism;

FIG. 6 is an exploded assembly view showing a height adjustable component of the toe kick adjustment mechanism; and

FIG. 7 is a broken partial top sectional view taken along line 7-7 of FIG. 5.

### DETAILED DESCRIPTION OF THE DRAWINGS

This disclosure pertains to installation features for appliances of various types, including kitchen appliances, such as refrigerators, wine cabinets, ice makers, trash compactors, dish washers and the like, and other household or commercial appliances, such as washers and dryers and the like. The installation features allow the installer to set the appliance in place and then making leveling and/or other installation adjustments from the front side of the appliance. Although the installation features can be utilized for various appliances, for simplicity the following description of the accompanying drawings pertains to a cool storage appliance.

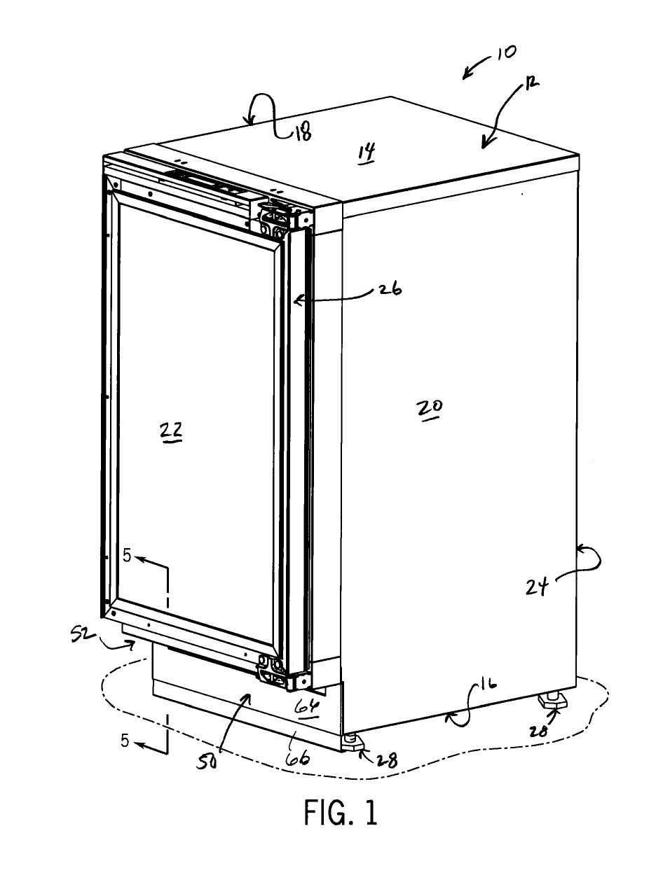

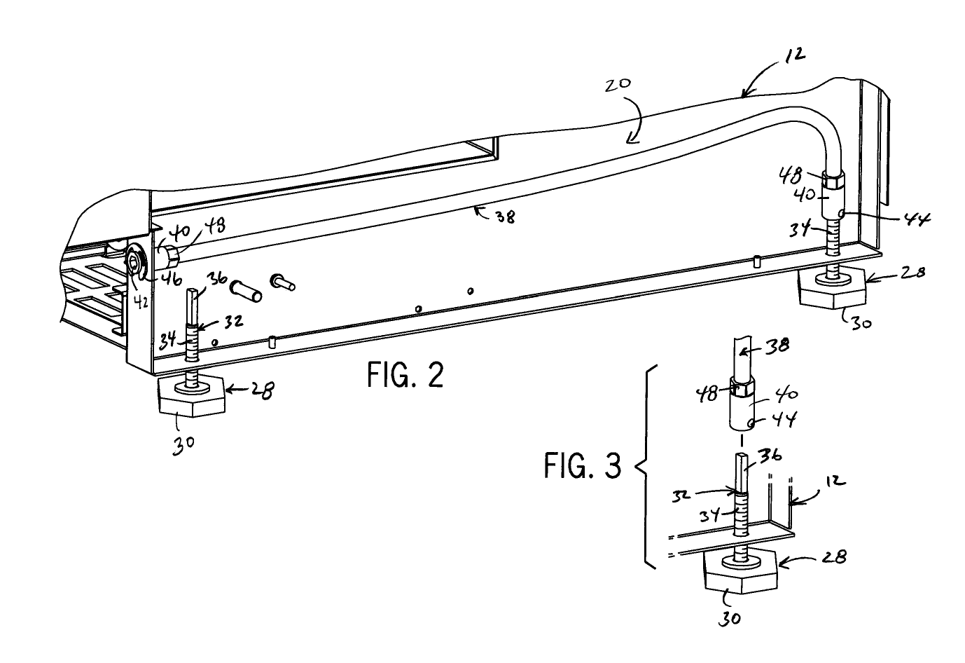

FIG. 1 of the drawings shows one example of a cooling unit 10 having installation features that are adjustable from the front side of the unit 10. By way of example, the cooling unit 10 can be a combination refrigerator/freezer having a refrigeration system and a freezer/ice-maker, as disclosed in U.S. Pat. No. 7,573,701, which is co-owned by this assignee and hereby incorporated as though fully set forth herein, particularly the disclosure at col. 3, line 54 to col. 6, line 44. Moreover, the cooling unit 10 can have a compact cabinet 12 sized for under-counter mounting with top 14, bottom 16, left 18, right 20, front 22 and back 24 sides. The front side 22 of the cabinet 12 is open and closed by a door 26 hinged to the cabinet 12 along the front side 22.

With the refrigeration system and the freezer/ice-maker as disclosed in the previously incorporated '701 patent, the installation features will now be described in detail. Specifically, the cabinet 12 has one or more legs 28 extending down from the bottom side 16, for example there can be four legs 28 located at or near the four corners of the cabinet 12. FIGS. 1 and 2 illustrate two such legs 28. Each of the legs 28 can be adjustably connected to the cabinet 12, such as via a threaded connection either in an opening in the wall forming the bottom side 16 as shown or a receptor insert or some other structure at the bottom side 16 of the cabinet 12. Also, one or more of the legs 28 may be fixedly connected to the cabinet 12 provided at least one of the legs 28 is adjustable sufficient to level the cabinet 12.

The legs 28 shown in the drawings have a six-sided contact pad 30 that sits against the floor or other supporting surface. A stem 32 extends up from the contact pad 30. The stem 32 has a first portion 34 that is threaded. The threads can be any suitable standard thread types, such as ISO metric, Unified Thread Standard, and British Standard Whitworth or other types of screw threads. Other known thread types could be used, such as ACME or other types of power screw threads. Internal threads of mating type would then be provided at the openings in the bottom side 16 of the cabinet 12. The stem 32 also has a second portion 36 that provides an interface for connecting the leg 28 to a flexible connector 38 that extends to the front side 22 of the cabinet 12. The second portion 36 of the stem 32 can have surfaces that interlock with the flexible connector 38, such as the four flat sides shown in the drawings.

The flexible connector 38 allows for manual adjustment of one or more rear legs 28 so that the cooling unit 10 can be leveled from the front side 22 of the cabinet 12. Two flexible connectors can be used to adjust two rear legs 28. However, more or fewer flexible connectors can be utilized depending upon the number of adjustable legs supporting the cooling unit 10. Moreover, although not shown in the drawings, flexible connectors can be utilized for front (or any intermediate) legs that might be used to support the cabinet 12.

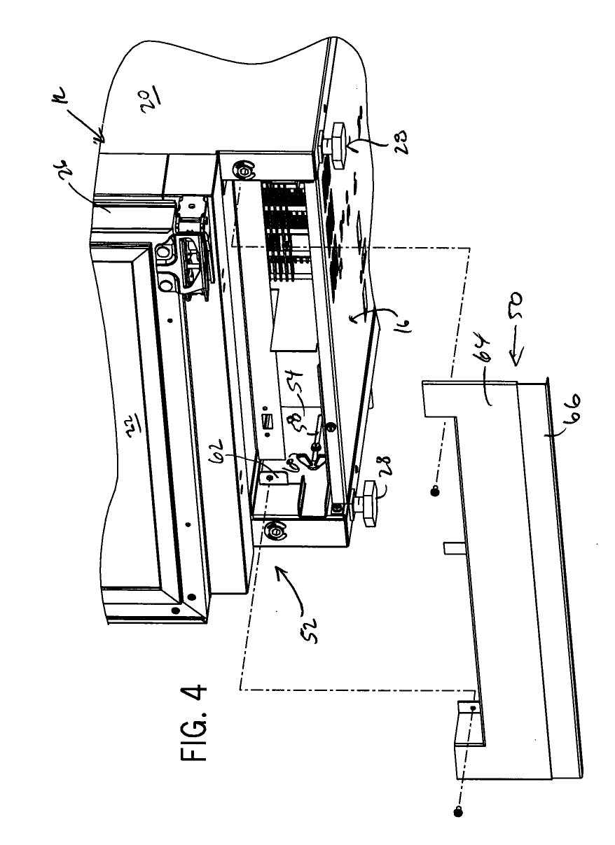

The flexible connector 38 is an elongated member that is flexible along its length. Each end of the flexible connector 38 includes a coupler 40. The couplers 40 can be identical or of different size and/or configuration, including being of the same or opposite gender. Couplers 40 shown in the drawings are the same at each end of the flexible connector 38. In the depicted example, the couplers 40 have open receptors 42 with a multi-sided opening corresponding to the configuration of the second portion 36 of the stem 32 of the associated leg 28. Engagement of the flat sides interlocks the coupler 40 to the portion 36 of the stem 32 so that rotational force can be transferred from the flexible connector 38 to the leg 28. A set screw 44 can be disposed in a transverse opening to positively secure the coupler 40 and stem 32. As mentioned, the coupler 40 at the other end of the flexible connector 38 can be identical to the coupler connected to the leg 28 having a multi-sided open receptor 42. As shown in FIGS. 1 and 2, the frontal coupler 40 can be mounted to the cabinet 12 at a front side wall by any suitable means, such as a snap ring 46. Also, as shown in FIG. 4, as mentioned there can be more than one such flexible connector 40, for example, one at each of the left 18 and right 20 sides of the cabinet 12 to allow for frontal access to both rear legs 28.

The flexible connector 38 can be of any suitable construction with respect to its elongated body and the end couplers 40. The couplers 40 can be as previously described, and the body can be a coaxial arrangement of a flexible core (not shown) surrounded by a flexible casing. Moreover, the body and couplers can be arranged to rotate in unison with the flexible core rotating within a stationary casing or together with the casing. As one example, the flexible core rotates within the casing. The core includes a solid metal wire wrapped in wire strands. The ends of the central wire and wire strands attach directly to the couplers 40 so that the wire, wire strands and couplers 40 move in unison. The wire and wire strands rotate within the casing, which is coupled to hex nuts 48 at its ends. The wire core provides flexing with sufficient rigidity to transfer rotational force input at the frontal coupler to the rear coupler, and thereby drive the associated leg 28. The casing helps in preventing debris, moisture and abrasion from effecting the movement of the wire core. Materials can be selected for the casing to minimize stretch and twist and provide a uniform bearing surface of the wire core, including layers of a metal liner, metal and cloth braiding and polymeric outer coat. An exemplary flexible connector is commercially available from Berg W. M., Inc. of Cudahy, Wis. in lengths of 1-36 inches and diameters of ⅛ to 1⅝ inches.

Thus, in use, the cooling unit 10 can be leveled from the front side 22 of the cabinet 12. This can be accomplished by adjusting the front legs as needed by lifting the front of the cabinet 12 slightly and rotating the front legs 28 relative to the cabinet 12. However, if there is no side to side unevenness, the front legs 28 can be kept at the factory set position so that the front of the cabinet need not be manually lifted. The rear legs 28 are adjusted for side to side and front to back leveling by inserting a tool, such as a hand or powered drill, wrench, screwdriver or the like into the receptor opening 42 of either or both of the front couplers 40 and rotating the coupler(s) 40. The rotational force is carried through the flexible connector(s) 38 to the rear coupler(s) 40, which engage and drive the stem 32 of the associated rear leg 28 to rotate in a clockwise or counter-clockwise direction relative to the cabinet 12, thereby raising or lowering the associated side or corner of the cabinet 12 as needed until the cooling unit 10 is level. It is noted that in the construction shown in the drawings, the front and rear couplers 40 are disposed at right angles to one another, that is, the open receptor 42 of the front coupler 40 is in the vertical plane and the open receptor 42 of the rear coupler is in the horizontal plane. Thus, the flexible connector(s) 38 must be sufficiently flexible to bend through a 90 degree angle within the depth of the cabinet 12. Additionally, it should be noted that the couplers 40 could be mounted so that they are more or less than 90 degrees out of plane, and thus the flexible connector(s) 38 would need to flexible sufficiently to accommodate the necessary included angle.

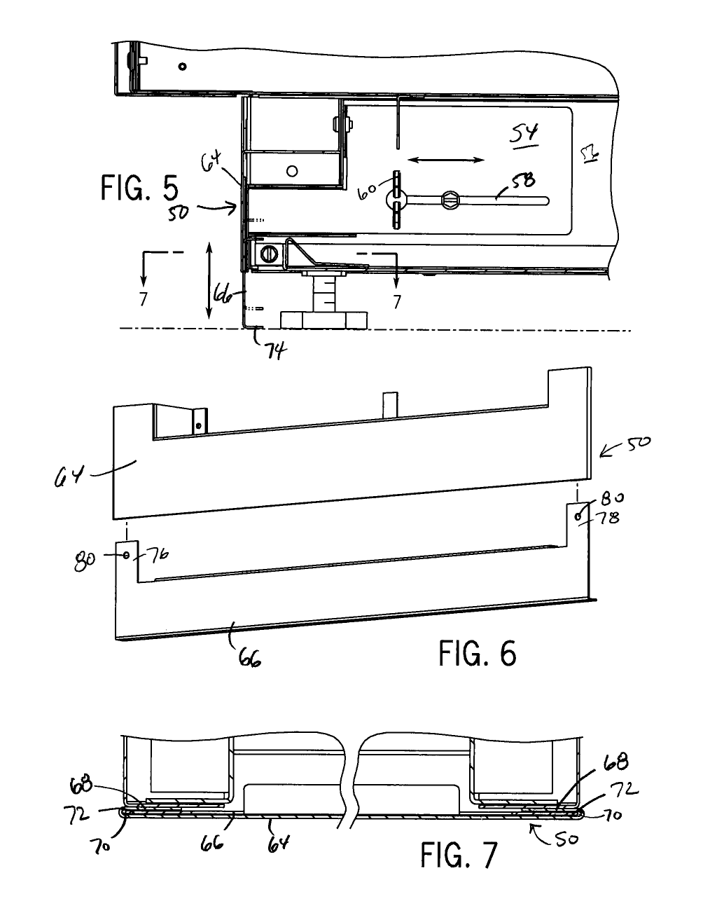

With reference to FIGS. 4-7 of the drawings, the cooling unit 10 can also include a toe kick 50 that can be adjusted from the front of the cabinet 12 as needed to mount flush with adjacent appliances or cabinetry (not shown). Specifically, the toe kick 50 can be located at a recessed grille area 52 at the bottom front side 22 of the cabinet 12, similar to the kick space commonly provided in floor-mounted kitchen cabinetry. To allow the toe kick 50 to align or otherwise be flush with the cabinet kick space, it can include both a depth (or from front to back) adjustment and a height (or top to bottom) adjustment. The depth adjustment is provided by one or more slider panels 54. By way of example, the slider panels 54 can be vertical walls that adjustably mount to interior upright walls 56 at the left 18 and right 20 sides of the cabinet 12. Either the walls 56 or the slider panels 54 (as shown) can have slots 58 to allow the slider panels 54 to slide forward and backward relative to the cabinet 12, and then secured in place by fasteners 60 disposed in the slots 58 after adjustment. The slider panels 54 can have bent tabs 62 for mounting, using suitable fasteners, a toe kick plate 64 that runs across the front side of the cabinet 12 at the recess 52. The toe kick plate 64 in turn mounts a floor gate 66 that can be adjusted in the top to bottom dimension. By way of example, the toe kick plate 64 has a planar front with opposite ends 68 that are bent over approximately 180 degrees so as to define narrow channels 70. The channels 70 capture the ends 72 of the floor gate 66, which can be a flat panel with a bent bottom edge 74.

Thus, in use, the entire toe kick 50 can be adjusted from the front side 22 of the cabinet. Once the cooling unit 10 is set into place, and possibly also leveled, the slider panels 54 are adjusted by first loosening the fasteners 60 and then tightening them again after the slider panels 54 are properly positioned. It may help to hold, or temporarily assemble, the toe kick plate 64 to the slider panels 54 to facilitate flush alignment of the toe kick plate 64 with adjacent cabinetry. Once the slider panels 54 are set, the ends 72 of the floor gate 66 are slid into the channels 70 of the toe kick plate 64. This assembly is then mounted to the slider panels 54 with fasteners. The floor gate 66 can be positioned by gravity or by manually sliding it down until the bent edge 74 contacts the floor. As shown in FIG. 6, the floor gate 66 (and the kick plate 64) have a U-shaped configuration from the front side 22 of the cabinet 12 with upwardly extending tabs 76 (and 78). The tabs, or other parts of the kick plate 64 and floor gate 66, can have locations 80 having detents or openings for fasteners to fix the vertical position of the floor gate 66. The kick plate 64 and/or the floor gate 66 can also be formed with open spaces, slits or the like to act as a grille allowing air flow at the bottom side 16 of the cabinet 12.

It should be appreciated that the above description describes one or more specific examples of the disclosed installation features for one exemplary type of appliance. However, many modifications and variations in use will be apparent to those skilled in the art, which will be within the spirit and scope of the invention. Therefore, the invention should not be limited to the described examples. To ascertain the full scope of the invention, the following claims should be referenced.

We claim:

1. An appliance with frontal installation adjustment, comprising:
a cabinet having a front side and a back side;
at least one leg adjustably mounted to the cabinet to support the cabinet and adjust the height of the back side of the cabinet;
an adjuster interface located at a front side of the cabinet; and
a flexible connector coupling the adjuster interface to the leg;
wherein the flexible connector transfers rotational force applied at the adjuster interface to the leg to raise or lower the back side of the cabinet.

2. The appliance of claim 1, wherein the adjuster interface has a tool receptor coupled to a proximal end of the flexible connector.

3. The appliance of claim 1, wherein the tool receptor has a recess with at least one flat interior surface.

4. The appliance of claim 1, further including a leg interface coupled to a distal end of the flexible connector.

5. The appliance of claim 4, wherein the leg has a threaded stem threadedly engaging the cabinet and a portion for engaging the leg interface.

6. The appliance of claim 5, wherein the leg interface has a leg receptor with a recess having at least one flat interior surface and the leg has a flat surface engaging the at least one flat interior surface of the leg receptor.

7. The appliance of claim 6, wherein the recesses of the tool receptor and the leg receptor open in different planes that are at an angle to one another.

8. The appliance of claim 1, further comprising an adjustable toe kick assembly mounted at a recess at a bottom of the front side of the cabinet.

9. The appliance of claim 8, wherein the toe kick assembly includes:
a toe kick panel mounted to the cabinet at the lower recess and being adjustable in the direction between the front and back sides of the cabinet; and
a floor gate mounted to the toe kick panel and being adjustable in the direction between top and bottom sides of the cabinet.

10. The appliance of claim 1, wherein the appliance is a cooling unit and the cabinet is refrigerated.

11. A cooling unit with frontal installation adjustment, comprising:
a refrigerated cabinet having opposite front and back sides and opposite top and bottom sides, the front side having a lower recess adjacent to the bottom side of the cabinet;
a toe kick panel mounted to the cabinet at the lower recess and being adjustable in the direction between the front and back sides of the cabinet; and
a floor gate mounted to the toe kick panel and being adjustable in the direction between the top and bottom sides of the cabinet.

12. The cooling unit of claim 11, wherein the toe kick panel is slidably mounted to the cabinet and the floor gate is slidably mounted to the toe kick panel.

13. The cooling unit of claim 12, wherein the toe kick panel includes a side wall at an angle to a front wall and wherein the side wall has a slot extending in a direction between the front and back sides of the cabinet in which a fastener mounted to the cabinet is disposed.

14. The cooling unit of claim 12, wherein one of the toe kick panel and the floor gate has a bent over end that forms a channel that receives an associated end of the other of the toe kick panel and the floor gate.

15. The cooling unit of claim 11, wherein the cabinet has at least one leg adjustably mounted to the cabinet to support the cabinet and adjust the height of the back side of the cabinet.

16. The cooling unit of claim 15, further including:
an adjuster interface located at a front side of the cabinet; and
a flexible connector coupling the adjuster interface to the leg;
wherein the flexible connector transfers rotational force applied at the adjuster interface to the leg to raise or lower the back side of the cabinet.

17. The cooling unit of claim 16, further including a tool receptor coupled to a proximal end of the flexible connector and a leg receptor coupled to a distal end of the flexible connector, wherein recesses of the tool receptor and the leg receptor open in different planes that are at an angle to one another.

18. The cooling unit of claim 17, wherein the leg has a threaded stem threadedly engaging the cabinet and a portion for engaging the leg interface, and wherein the leg receptor recess has at least one flat interior surface and the leg has a flat surface engaging the at least one flat interior surface of the leg receptor.

19. A method of installing an appliance having a cabinet with front, back, top and bottom sides, the method comprising:
(a) leveling the cabinet, including:
applying a rotational force to an adjuster interface located at the front side of the cabinet;
transferring the rotational force applied at the adjuster interface along a flexible connector to at least one leg adjustably mounted to the cabinet; and
the flexible connector rotating the leg to adjust the height of the back side of the cabinet.

20. The method of claim 20, further comprising:
(b) positioning a toe kick at a lower recess at the front side of the cabinet, including:
adjusting a kick panel of the toe kick mounted to the cabinet in the direction between the front and back sides of the cabinet;
adjusting a floor gate mounted to the kick panel in the direction between the top and bottom sides of the cabinet.
